(19) United States
(12) Patent Application Publication
(10) Pub. No.: US 2026/0350649 A1
(43) Pub. Date: Nov. 5, 2026

(54) METHOD FOR APPLYING INDIVIDUALIZED IDENTIFICATION AND OBTAINING PRODUCT CONSUMPTION DATA

(71) Applicant: COMPANHIA BRASILATA LABS, Jundiaí (BR)

(72) Inventors: Augusto Ferreira FRANÇA, São Paulo (BR); Gabriel Heleno ZARAGUETA, São Paulo (BR)

(21) Appl. No.: 19/487,773

(22) PCT Filed: May 29, 2024
(86) PCT No.: PCT/BR2024/050220

§ 371 Date: Nov. 25, 2025

(30) Foreign Application Priority Data
May 29, 2023 (BR) 1020230103740

(51) Int. Cl. G06Q 30/0217; G06Q 30/0201

(52) U.S. Cl. CPC G06Q 30/0217; G06Q 30/0201

(57) ABSTRACT

A method includes the following steps: generating an individualized identification code for each of the products from a set of basic identifying data for a group of products; providing a promotion management server, which contains the individualized identification codes and to be accessed through an application on a consumer's computing device; defining a positioning for each code on a portion of substrate that forms a respective product; printing each code on a respective portion of substrate; disclosing that consumption of the products is associated to a promotion, loyalty, or reward program; and collecting, from the promotion management server, the consumption data automatically received therein and pertaining to the products on which the codes have been submitted for reading using the application loaded on the consumer's computing device.

### CROSS-REFERENCE TO RELATED APPLICATIONS

The present application is the National Phase entry of International Patent Application No. PCT/BR2024/050220 filed May 29, 2024, which claims priority to Brazilean Patent Application No. 1020230103740 filed May 29, 2023, the contents of which are herein incorporated by reference.

### TECHNICAL FIELD

The present disclosure relates to a method for enabling the application of individualized identification to different products, such as those related to food, cleaning or personal hygiene, which are packaged in bottles sealed with metal caps, cans or boxes made of different sheet materials, provided with unique individual identification and whose consumption can be associated, by consumers, with a determined promotion, loyalty program or reward. The proposed method allows the manufacturer, with the individualized identification of the products, effective traceability and the collection of valuable data about the consumer behavior and the performance of the product, in addition to helping prevent product falsification and theft.

### BACKGROUND

It is known in the art to use different codes, such as QR codes, barcodes or other generally two-dimensional codes, to be printed on a part of a product's packaging, to be captured by the camera of a computing device such as a smartphone, tablet, notebook or desktop. The data incorporated into the code may be related to several types of information regarding the product, such as serial and/or batch numbers, manufacturing and expiration dates, or other information that the product manufacturer considers relevant to itself and to the consumer.

The known codes are used in the characterization of batches of products of a same type, for carrying out different automated production and stock controls by the manufacturer, of consumption by the retailer, and also to facilitate not only consumer participation in promotions offered by manufacturers and retailers, but also to provide the latter with a more efficient way to manage promotions of their products, as occurs with the method proposed in patent document BR 10 2017 011599-2.

In these cases, there is no individualized identification, exclusive to each package of the products, and not being possible for the manufacturer to identify data related to the consumption of an individual item from a product family.

Another well-known use of codes on consumer product packages is described in patent BR 10 2018 076344-0, which deals with a method and a production chain management system, according to which the products receive an individual code, generated from product data that is stored in a database to be accessed by the user/consumer, according to different access levels, to make available to the user updated data of the product and also to allow the user to enter product data into the database, enabling the user to obtain information related to collection points and incentives for recycling and/or proper disposal of the product.

Although it uses an individualized code for the products, the solution proposed in patent BR 10 2018 076344-0 does not provide means for the simple capture of the product code by the camera of the consumer's computing device, within a specific application, to automatically promote the delivery of the product code to a promotion management server, where the consumption data of the read products remains available to the manufacturer.

### SUMMARY

Due to the aforementioned operational limitation and related to the operations required by the consumer so that the consumption data of products can be made available to the manufacturer, the present disclosure aims to provide a method to allow each product to be transformed into a single product and that the manufacturer can obtain consumption data for its products from the simple reading of an individualized identification code, exclusive to each individual package and printed thereon, wherein the printing can be provided on the lid, on the bottom or on the body of the product package, on the outside or inside of one of the packaging components.

### DEATIELD DESCRIPTION

According to the present disclosure, the method initially comprises the step of defining, generally by the manufacturer, a set of basic identifying data of a group of products to be associated with a promotion, loyalty program or reward, and whose consumption data is to be obtained. These basic data may information about the manufacturer and the product, such as serial and/or batch numbers, manufacturing and expiration dates, or even automatically directing the consumer to a digital document that can be accessed via internet and that is generally created using markup languages such as HTML, CSS and JavaScript, which are used to provide information, services and entertainment to internet users.

From the basic identifying data defined for a group of products, the method includes the step of generating, through an appropriate software, an individualized identification code for each of the products related to the promotion, loyalty, or reward program, wherein said codes are readable by a computing device operated by the consumer and loaded with a consumer application for those products.

As already mentioned, the computing device can be defined by a smartphone, tablet, notebook or desktop, equipped with a camera and capable of performing the reading of a code that is printed on the product. The individualized identification code for each product can take the form of a QR code, a barcode or any other code readable by the consumer's computing device and capable of associating each product with basic identifying data and an individual identification.

The method also requires the provision of a promotion management server, loyalty or reward program, to be operated by the product manufacturer itself or by a third party, in the form of a data processing center (DPC), and which contains a database defined by the individualized identification codes of the products and to be accessed through the application loaded on the computing device of a consumer of said products.

With the individualized identification codes for the products in the product group already defined, the method includes the step of defining a position for each code on a substrate that defines at least one portion of substrate to be used as the forming material of a respective product to have its individualized identification.

The substrate can be defined by a sheet of metallic, polymeric or cellulosic material, with each portion of the substrate, in which the exact position to be occupied by the respective individualized identification code is defined, being dimensioned to define the material of the entire packaging of a product or of a respective part of the packaging.

A sheet of material, defining the substrate, generally presents a plurality of substrate portions, each one of the portions having, defined thereon, an exact positioning for the individualized identification code. The positioning of the individualized identification codes is adjusted according to the characteristics of the packaging or packaging part in which it will be incorporated. The packaging part can be defined, for example, by the metal cap of a beverage bottle or by a portion of metal, polymeric or cellulosic sheet, configured to form the body of a can or box.

Once the positioning of each individual identification code is defined, the digital printing step of each code can be carried out in the defined position on each respective portion of the product's forming substrate. The digital printing allows a quick and precise printing of the codes, ensuring that each product is correct and individually identified.

For the effectiveness of the method of obtaining consumption data, it includes the step, to be carried out at an appropriate time and by any means of disclosure, of disclosing to the potential consumers that the consumption of the products is associated with a promotion, loyalty program or reward, accessible through the application for accessing the database of the promotion management server.

Finally, the method includes the step of collecting, from the promotion management server, the consumption data automatically received therein and relating to products whose individualized identification code has been submitted for reading through the use of the application loaded on the consumer's computing device.

The method in question allows the reading of the product code, through the computing device of the consumer, to automatically promote, via internet, the sending of the data of that specific product, associated with the code, printed thereon, to the promotion management server, making said data easily available to the manufacturer, and which can be used for precise traceability of the consumption of each product in the promotion, the collection of data on consumer behavior and product performance in different regions, in addition to facilitate the management of the obligations of the promotion program.

1. A method for applying individualized identification and obtaining product consumption data, the method comprising:
a) defining a set of basic identifiying data for a group of products related to a promotion, loyalty, or reward program;
b) generating an individualized identification code for each of the products related to the promotion, loyalty, or reward program, the individualized identification codes are readable by a computing device operated by a consumer and loaded with an application;
c) providing a promotion management server, containing a database defined by the individualized identification codes of the products and to be accessed through the application loaded on the computing device of the consumer of the products;
d) defining a positioning, for each individualized identification code, on a substrate defining at least one portion of substrate to be used as a forming material of a respective product to have its identification individualized;
e) printing the individualized identification code of each product in the defined positioning on the respective portion of the substrate used for forming the product;
f) disclosing to potential consumers of the products that the consumption of the products is associated with the promotional, loyalty, or reward program, accessible through the application for accessing the database of the promotion management server; and
g) collecting, from the promotion management server, the product consumption data automatically received therein and relating to products whose individualized identification code has been submitted to a reading through a use of the application loaded on the computing device of the consumer.

2. The method according to claim 1, wherein the promotion management server is operated by a manufacturer of the products having the individualized identification.

3. The method according to claim 1, wherein the application for accessing the promotion management server provides automatic transmission to the server of the reading of the individualized identification code when it is performed by the consumer.

4. The method according to claim 1, wherein the printing of the individualized identification code is made digitally on a respective portion of substrate, defined by a sheet portion of metallic, polymeric or cellulosic material.

5. The method according to claim 4, wherein each portion of metallic, polymeric or cellulosic sheet defines the forming material of the packaging body of the product or part of the packaging.

6. The method according to claim 2, wherein the application for accessing the promotion management server provides automatic transmission to the server of the reading of the individualized identification code when it is performed by the consumer.

7. The method according to claim 2, wherein the printing of the individualized identification code is made digitally on a respective portion of substrate, defined by a sheet portion of metallic, polymeric or cellulosic material.

8. The method according to claim 3, wherein the printing of the individualized identification code is made digitally on a respective portion of substrate, defined by a sheet portion of metallic, polymeric or cellulosic material.

9. The method according to claim 6, wherein the printing of the individualized identification code is made digitally on a respective portion of substrate, defined by a sheet portion of metallic, polymeric or cellulosic material.

10. The method according to claim 7, wherein each portion of metallic, polymeric or cellulosic sheet defines the forming material of the packaging body of the product or part of the packaging.

11. The method according to claim 8, wherein each portion of metallic, polymeric or cellulosic sheet defines the forming material of the packaging body of the product or part of the packaging.

12. The method according to claim 9, wherein each portion of metallic, polymeric or cellulosic sheet defines the forming material of the packaging body of the product or part of the packaging.
